(19) United States
(12) Patent Application Publication
(10) Pub. No.: US 2018/0266369 A1
(43) Pub. Date: Sep. 20, 2018

(54) EXHAUST HEAT RECOVERY DEVICE

(71) Applicant: FUTABA INDUSTRIAL CO., LTD., Okazaki-shi, Aichi (JP)

(72) Inventors: Hiromi Ishikawa, Okazaki-shi, Aichi (JP); Hirohisa Okami, Okazaki-shi, Aichi (JP)

(73) Assignee: FUTABA INDUSTRIAL CO., LTD., Okazaki-shi, Aichi (JP)

(21) Appl. No.: 15/761,367

(22) PCT Filed: Jan. 22, 2016
(86) PCT No.: PCT/JP2016/051914

§ 371 Date: Mar. 19, 2018

(51) Int. Cl. F02M 26/32; F02M 26/24; F02M 26/28; F02M 26/25

(52) U.S. Cl. CPC F02M 26/32; F02M 26/25; F02M 26/28; F02M 26/24

(57) ABSTRACT

An exhaust heat recovery device according to one aspect of the present disclosure includes a main flow path, a secondary flow path, one or a plurality of heat exchangers, and one or a plurality of covering members. Exhaust gas flows in the main flow path. The secondary flow path is a flow path branched from the main flow path and is disposed surrounding a circumference of the main flow path. At least a portion of the exhaust gas flows in the secondary flow path. One or a plurality of the heat exchangers is arranged in the secondary flow path. One or a plurality of the covering members covers at least a portion of a circumference of the heat exchanger, and an internal space constitutes a portion of the secondary flow path. The covering member is provided with an exhaust gas outlet.

### TECHNICAL FIELD

The present disclosure relates to a technique for recovering heat from exhaust gas using a heat exchanger.

### BACKGROUND ART

The following Patent Document 1 discloses an exhaust gas recovery device having a heat exchanger around a main flow path for exhaust gas, in which a branch portion for taking out exhaust gas is provided at a pipe after the exhaust gas having passed through the heat exchanger.

### PRIOR ART DOCUMENTS

### Patent Documents

Patent Document 1: Japanese Unexamined Patent Application Publication No. 2008-163773

### SUMMARY OF THE INVENTION

### Problems to be Solved by the Invention

However, in the type in which a pipe is branched, the branch portion tends to be affected by vibration, and there is a problem that in order to secure the strength of this portion, the size and weight are inevitably increased.

In one aspect of the present disclosure, it is desirable that in a technique for recovering heat from exhaust gas using a heat exchanger, the exhaust gas can be taken out while suppressing the increase in size or weight of the device.

### Means for Solving the Problems

An exhaust heat recovery device according to one aspect of the present disclosure comprises a main flow path, a secondary flow path, one or a plurality of heat exchangers, and one or a plurality of covering members. Exhaust gas flows through the main flow path. The secondary flow path is a flow path branched from the main flow path and is disposed surrounding a circumference of the main flow path. At least a portion of the exhaust gas flows through the secondary flow path.

One or a plurality of the heat exchangers is arranged in the secondary flow path. One or a plurality of the covering members covers at least a portion of a circumference of the heat exchanger, and an internal space constitutes a portion of the secondary flow path. The covering member is provided with an exhaust gas outlet.

According to such an exhaust heat recovery device, since the exhaust gas outlet is disposed at the covering member in the configuration in which the secondary flow path is disposed surrounding the circumference of the main flow path, an outlet can be provided in a relatively thick portion. Accordingly, as compared with a case where a pipe is branched to provide an outlet, it is possible to make it hard to be adversely affected by vibration of the pipe.

In addition, in the configuration in which a branch portion is provided at a pipe, the configuration including the exhaust heat recovery device and the branch portion of the pipe is likely to increase in size. However, in this configuration, exhaust gas can be taken out while suppressing the increase in size or weight of the device.

In the exhaust heat recovery device according to one aspect of the present disclosure, the heat exchanger may comprise a liquid flow path through which a liquid to be heat-exchanged with exhaust gas flows, and the exhaust gas may be allowed to pass around the liquid flow path.

According to such an exhaust heat recovery device, since the exhaust gas is allowed to pass around the liquid flow path, the exhaust gas outlet can be provided at an arbitrary position outside the heat exchanger. Thus, the degree of freedom of arrangement of the exhaust gas outlet can be improved.

Further, in the exhaust heat recovery device according to one aspect of the present disclosure, the exhaust gas outlet may be an outlet for exhaust gas used for exhaust gas recirculation.

According to such an exhaust heat recovery device, the exhaust gas cooled by the heat exchanger can be recirculated.

### BRIEF DESCRIPTION OF THE DRAWINGS

FIG. 1 is a perspective view showing an appearance of an exhaust heat recovery device according to an embodiment.

FIG. 2 is a cross-sectional view of the exhaust heat recovery device in a valve-closed state, taken along the line II-II in FIG. 1.

FIG. 3 is a cross-sectional view of an exhaust heat recovery device according to another embodiment.

### EXPLANATION OF REFERENCE NUMERALS

1 . . . exhaust heat recovery device, 2 . . . exhaust portion, 4 . . . shell member, 6 . . . heat exchange unit, 8 . . . inflow portion, 10 . . . valve, 12, 14 . . . exhaust pipe, 18 . . . exhaust downstream end, 20 . . . outer shell member, 22 . . . lid member, 24 . . . holding member, 28 . . . heat exchange chamber, 30 . . . heat exchanger, 44 . . . inflow pipe, 46 . . . outflow pipe, 56 . . . introduction member, 71 . . . exhaust gas outlet, 72 . . . EGR pipe, 80 . . . liquid flow path, 91 . . . main flow path, 92 . . . secondary flow path, 144 . . . coolant, 142 . . . exhaust gas.

### MODE FOR CARRYING OUT THE INVENTION

Hereinafter, exemplary embodiments of the present disclosure will be described with reference to the drawings.

[1-1. Overview of Exhaust Heat Recovery Device]

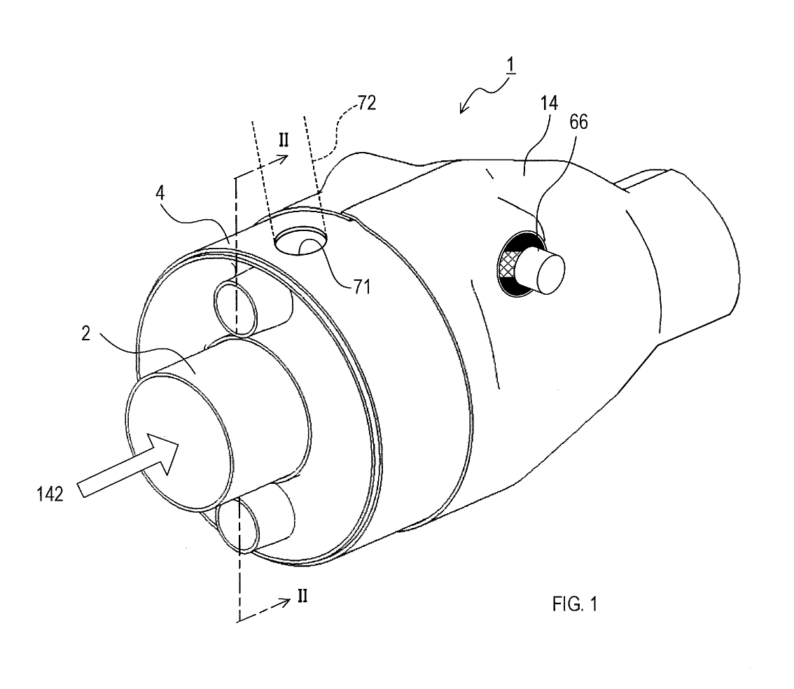

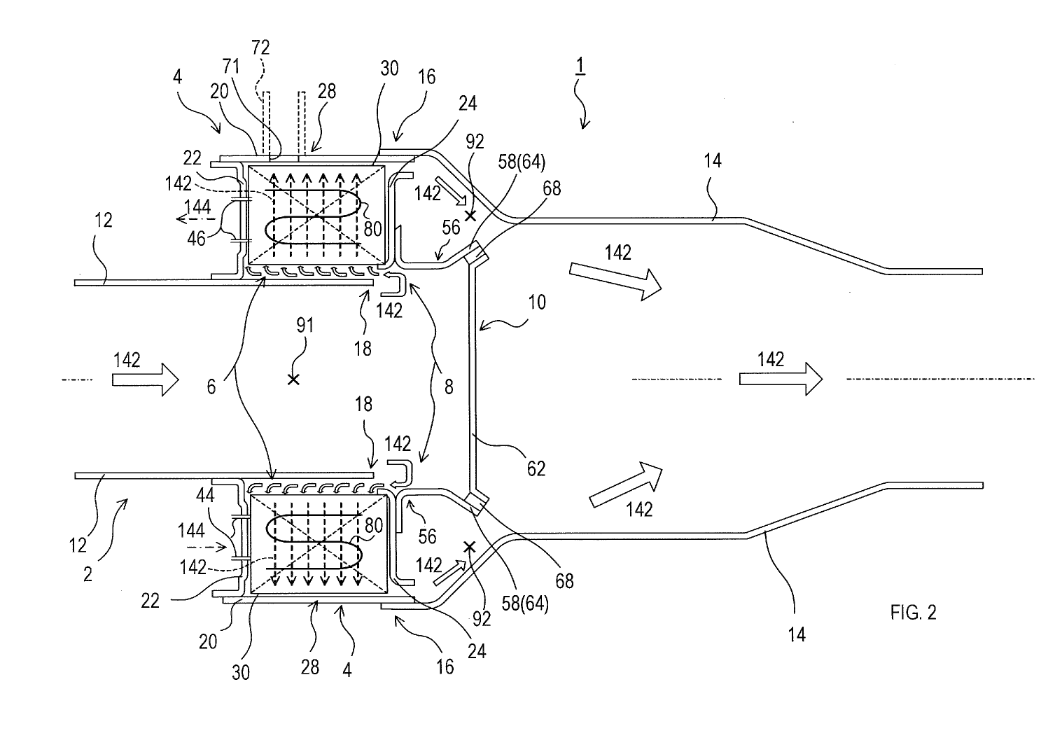

An exhaust heat recovery device 1 shown in FIGS. 1 and 2 is installed in a moving object having an internal combustion engine, such as a passenger car. The exhaust heat recovery device 1 recovers heat from exhaust gas 142 such as exhaust gas from an internal combustion engine, which is a high temperature fluid, by transferring heat of the exhaust gas 142 to a coolant 144 of the internal combustion engine, which is a low temperature fluid lower in temperature than the exhaust gas 142. The coolant 144 in the present embodiment may be cooling water or oil liquid.

The exhaust heat recovery device 1 of the present embodiment comprises an exhaust portion 2, a shell member 4, a heat exchange unit 6, an inflow portion 8, and a valve 10.

The exhaust portion 2 forms a flow path that guides the exhaust gas 142 from the internal combustion engine to the downstream side. The shell member 4 is a member covering outside of the exhaust portion 2. The heat exchange unit 6 has a heat exchanger 30 disposed between the exhaust portion 2 and the shell member 4, and exchanges heat between the exhaust gas 142 and the coolant 144.

As shown in FIG. 2, the inflow portion 8 is a portion where the exhaust gas 142 flows from the exhaust portion 2 into the heat exchange unit 6. The valve 10 is a valve that opens or closes the flow path for the exhaust gas 142 and is located downstream of the inflow portion 8 along the flow path for the exhaust gas 142 in the exhaust portion 2.

When the valve 10 is opened, most of the exhaust gas 142 does not pass through the heat exchange unit 6 but passes through the main flow path 91 to flow downstream of the valve 10. When the valve 10 is closed, most of the exhaust gas 142 passes through a secondary flow path 92 passing through the heat exchange unit 6 to flow downstream of the valve 10. That is, the valve 10 switches the flow path for the exhaust gas 142 according to opening and closing.

The valve 10 is opened and closed by an actuator such as a well-known motor or thermoactuator. The main flow path 91 represents the flow path for the exhaust gas 142 formed mainly by the exhaust pipes 12 and 14 and an introduction member 56. The secondary flow path 92 mainly represents a flow path surrounded by an exhaust downstream end 18, an outer shell member 20, a lid member 22, and a holding member 24. The secondary flow path 92 is a flow path branched from the main flow path 91 and is formed around the main flow path 91. In the present embodiment, particularly, the secondary flow path 92 is formed surrounding the main flow path 91. The term “surrounding” includes the fact that at least a portion is covered. That is, the secondary flow path 92 needs not necessarily be disposed over the entire circumference of the main flow path 91, and may be disposed so as to cover at least a portion of the main flow path 91.

In other words, the exhaust heat recovery device 1 has a coaxial structure. The coaxial structure indicates a configuration in which the center axis of the main flow path 91 coincides with the central axes of members formed annularly around the main flow path 91, such as the secondary flow path 92 and the heat exchanger 30.

[1-2. Structure of Exhaust Heat Recovery Device]

As shown in FIG. 2, the exhaust portion 2 is provided with the exhaust pipe 12. The exhaust pipe 12 is formed in a cylindrical shape with both ends opened. The exhaust pipe 12 is connected to an exhaust pipe, an exhaust manifold or the like into which the exhaust gas 142 from the internal combustion engine flows.

The shell member 4 comprises an exhaust pipe 14, the outer shell member 20, the lid member 22, and the holding member 24. The exhaust pipe 14 is formed in a cylindrical shape with both ends opened.

The outer shell member 20 is formed in a cylindrical shape having an inner diameter larger than the diameter of the exhaust pipe 12 with both ends opened. An end portion on the downstream side of the outer shell member 20 is connected to an upstream end 16 of the exhaust pipe 14.

The lid member 22 closes the opening on the upstream side of the outer shell member 20 along the flow path for the exhaust gas 142 i.n the exhaust pipe 12. That is, the outer shell member. 20, the lid member 22, and the exhaust pipe 12 form a heat exchange chamber 28 which is an annular space surrounded by the outer shell member 20, the lid member 22, and the exhaust pipe 12.

As the heat exchanger 30 disposed in the heat exchange chamber 28, an arbitrary heat exchanger such as a well-known heat exchanger for carrying out heat exchange with heat exchange fins (not shown) can be adopted. However, the heat exchanger 30 is configured such that the exhaust gas 142 flows around the liquid flow path 80. For example, the exhaust gas 142 flows through gaps between heat exchange fins formed around the liquid flow path 80, so that heat exchange between the exhaust gas 142 and the coolant 144 is carried out.

The coolant 144 flows into the heat exchanger 30 from the inflow pipe 44 penetrating the lid member 22, and after heat exchange is carried out inside the heat exchanger 30, the coolant 144 flows outside the heat exchanger 30 via the outflow pipe 46 penetrating lid member 22. The inflow pipe 44 and the outflow pipe 46 may penetrate the outer shell member 20, not necessarily the lid member 22.

The holding member 24 holds the heat exchanger 30 disposed in the heat exchange chamber 28.

The inflow portion 8 comprises the introduction member 56. An opening is formed in the circumferential direction between the exhaust downstream end 18 of the exhaust pipe 12 and the introduction member 56. The opening between the exhaust downstream end 18 of the exhaust pipe 12 and the introduction member 56 functions as an inlet for the exhaust gas 142 to the heat exchange unit 6.

The valve 10 has at least a valve body 62, a valve seat 64, and a valve shaft 66. The valve body 62 is a disk-shaped member having a diameter larger than the diameter of the introduction member 56 (exhaust pipe 12). The valve shaft 66 is a shaft connected to the valve body 62 and is a shaft for driving the valve body 62.

The valve seat 64 is a member that comes into contact with the valve body 62 and thereby closes the exhaust portion 2 (introduction member 56). The valve seat 64 in the present embodiment is a distal end portion 58 of the introduction member 56. A mesh member 68 formed in a mesh shape is attached to an inner circumferential surface of the valve seat 64.

Here, the outer shell member 20 is formed with an exhaust gas outlet 71 which is an outlet for exhaust gas used for exhaust gas recirculation (EGR). The exhaust gas outlet 71 is disposed in a region where the exhaust gas having passed through the heat exchanger 30 flows in the heat exchange chamber 28. In other words, the exhaust gas outlet 71 is disposed at a position separated by the heat exchanger 30 as seen from the inflow portion 8, and is set such that the exhaust gas 142 having passed through the heat exchanger 30 is supplied to the exhaust gas outlet 71.

An EGR pipe 72 is connected to the exhaust gas outlet 71. In the EGR pipe 72, a well-known EGR valve (not shown) is provided, and when the EGR valve is opened, a portion of the exhaust gas 142 flows into the EGR pipe 72. That is, the exhaust gas 142 cooled by passing through the heat exchanger 30 is supplied to the EGR pipe 72.

[1-3. Effects]

According to the first embodiment detailed above, the following effects can be obtained.

(1a) The exhaust heat recovery device 1 described above comprises the main flow path 91, the secondary flow path 92, one or a plurality of the heat exchangers 30, and one or a plurality of the covering members. The covering member represents at least one of the exhaust pipe 12, the outer shell member 20, and the lid member 22.

Exhaust gas flows in the main flow path 91. The secondary flow path 92 is a flow path branched from the main flow path 91 arid is disposed surrounding the circumference of the main flow path 91. At least a portion of the exhaust gas flows in the secondary flow path 92.

One or a plurality of the heat exchangers 30 is arranged in the secondary flow path 92. One or a plurality of the covering members covers at least a portion of the circumference of the heat exchanger 30, and the internal space constitutes a portion of the secondary flow path 92. The covering member is provided with the exhaust gas outlet 71.

According to the exhaust heat recovery device 1 thus configured, since the exhaust gas outlet 71 is disposed in the covering member in the configuration in which the secondary flow path 92 is disposed surrounding the circumference of the main flow path 91, the outlet 71 can be provided in a relatively thick portion. Accordingly, as compared with a case where a pipe is branched to provide the outlet 71, it is possible to make it hard to be adversely affected by vibration of the pipe.

In addition, in the configuration in which a branch portion is provided at a pipe, the configuration including the exhaust heat recovery device 1 and the branch portion of the pipe is likely to increase in size. However, in this configuration, exhaust gas can be taken out while suppressing the increase in size or weight of the device.

(1b) In the exhaust heat recovery device 1 described above, the heat exchanger 30 comprises the liquid flow path 80 through which a liquid to be heat-exchanged with exhaust gas flows, and the exhaust gas is allowed to pass around the liquid flow path 80.

According to the exhaust heat recovery device 1 thus configured, since the exhaust gas is allowed to pass around the liquid flow path 80, the exhaust gas outlet 71 can be provided at an arbitrary position outside the heat exchanger 30. Thus, the degree of freedom of arrangement of the exhaust gas outlet 71 can be improved.

(1c) In the exhaust heat recovery device 1 described above, the exhaust gas outlet 71 is the outlet 71 for exhaust gas used for exhaust gas recirculation.

According to the exhaust heat recovery device 1 thus configured, the exhaust gas cooled by the heat exchanger 30 can be recirculated.

[2. Another Embodiment]

Although the embodiment for carrying out the present disclosure has been described above, the present disclosure is not limited to the above-described embodiment, and various modifications can be made.

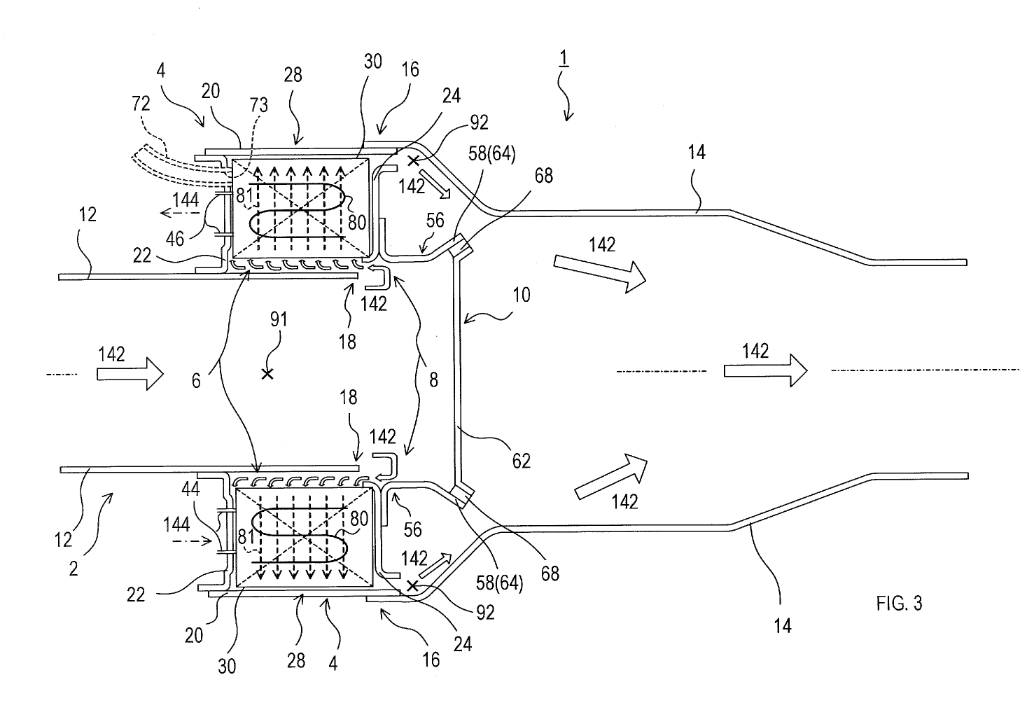

(2a) In the above embodiment, although the exhaust gas outlet 71 is disposed in the outer shell member 20, the present disclosure is not limited thereto, and the exhaust gas outlet 71 may be disposed in a member covering the heat exchanger 30. For example, as the member covering the heat exchanger 30, as shown in FIG. 3, the exhaust gas outlet 71 may be disposed in the lid member 22.

Even in such a ease, the same effect as in (1a) described above can be obtained.

(2b) The functions of one constituent element in the above embodiment may be dispersed as a plurality of constituent elements, or the functions of a plurality of constituent elements may be integrated to one constituent element. Further, some configurations of the above embodiment may be omitted. Furthermore, at least some configurations of the above embodiment may be added to or replace configurations of another above-described embodiment. All aspects included in the technical concept identified solely by the expressions recited in the claims are embodiments of the present disclosure.

(2c) in addition to the exhaust heat recovery device 1 described above, the present disclosure can be realized in various forms such as a system including the exhaust heat recovery device 1 as a component and an exhaust heat recovery method.

[3. Correspondence Relationship Between Configuration of the Present Embodiment and Configuration of the Present Disclosure]

The exhaust pipe 12, the outer shell member 20, and the lid member 22 in the above embodiment correspond to an example of a covering member according to the present disclosure.

1. An exhaust heat recovery device comprising:
a main flow path configured such that exhaust gas flows therethrough;
a secondary flow path that is a flow path branched from the main flow path, is disposed surrounding a circumference of the main flow path, and is configured such that at least a portion of the exhaust gas flows therethrough;
one or a plurality of heat exchangers arranged in the secondary flow path; and
one or a plurality of covering members covering at least a portion of a circumference of the heat exchanger and configured such that an internal space constitutes a portion of the secondary flow path,
wherein the covering member comprises an exhaust gas outlet.

2. The exhaust heat recovery device according to claim 1, wherein the heat exchanger comprises a liquid flow path configured such that a liquid to be heat-exchanged with the exhaust gas flows therethrough and is configured to allow the exhaust gas to pass around the liquid flow path.

3. The exhaust heat recovery device according to claim 1, wherein the exhaust gas outlet is an outlet for exhaust gas used for exhaust gas recirculation.

4. The exhaust heat recovery device according to claim 2, wherein the exhaust gas outlet is an outlet for exhaust gas used for exhaust gas recirculation.
